(19) United States
(12) Patent Application Publication
(10) Pub. No.: US 2024/0384766 A1
(43) Pub. Date: Nov. 21, 2024

(54) DISK BRAKE

(71) Applicant: Hitachi Astemo, Ltd., Hitachinaka-shi, Ibaraki (JP)

(72) Inventors: Daichi NOMURA, Hitachinaka-shi, Ibaraki (JP); Haruhiko FUJITA, Hitachinaka-shi, Ibaraki (JP)

(21) Appl. No.: 18/690,077

(22) PCT Filed: Nov. 22, 2022
(86) PCT No.: PCT/JP2022/043128

§ 371 Date: Mar. 7, 2024

(30) Foreign Application Priority Data
Dec. 21, 2021 (JP) 2021-207082

(51) Int. Cl. F16D 55/226; B60T 13/74; F16D 65/18; F16D 121/24; F16D 125/40; H02K 7/06; H02K 11/33

(52) U.S. Cl. CPC F16D 55/226; F16D 65/18; H02K 7/06; H02K 11/33; B60T 13/746; F16D 2121/24; F16D 2125/40; H02K 2211/03

(57) ABSTRACT

A disk brake includes a first board portion connected to an electric motor and disposed opposite from a rotational shaft side of the electric motor in an axial direction of the rotational shaft, and a second board portion connected to the first board portion and disposed so as to face the first board portion and be spaced apart from the first board portion by a predetermined distance. This configuration contributes to suppressing a transfer of a vibration and/or heat passed from the rotational shaft of the electric motor to components mounted on the first and second board portions. As a result, a malfunction of the components mounted on the first board portion and the second board portion can be reduced, and the reliability of the present disk brake is improved.

### TECHNICAL FIELD

The present invention relates to a disk brake used to brake a vehicle.

### BACKGROUND ART

There is disclosed such a technique that a motor is configured in such a manner that a control circuit board and a drive circuit board are arranged so as to be stacked along an axial direction of an output shaft of the motor to improve the mountability of a control apparatus, as discussed in PTL 1.

### CITATION LIST

### PATENT LITERATURE

PTL 1: Japanese Patent Application Laid-Open No. 2010-28925

### SUMMARY OF INVENTION

### TECHNICAL PROBLEM

In the motor disclosed in PTL 1, the output shaft of the motor is provided on the control circuit board and drive circuit board side. However, in a case of a disk brake actuated by an electric motor, providing these control circuit board and drive circuit board on the motor output shaft side may lead to a reduction in the reliability due to a transfer of a vibration and/or heat passed from the motor or the disk rotor to these control circuit board and drive circuit board, more specifically, components mounted on these control circuit board and drive circuit board, raising the necessity of improvement.

Under these circumstances, one of objects of the present invention is to provide a disk brake capable of suppressing a transfer of a vibration and/or heat passed from a motor or a disk rotor to a component mounted on a board, thereby improving reliability.

### SOLUTION TO PROBLEM

As a means for achieving the above-described object, a disk brake according to the present invention includes a motor, a rotation-linear motion conversion mechanism configured to convert a rotational motion transmitted from an output shaft of the motor into a linear motion to cause a frictional pad to be pressed, a first board portion connected to the motor and disposed opposite from an output shaft side of the motor in an axial direction of the output shaft, and a second board portion connected to the first board portion and disposed so as to face the first board portion and be spaced apart from the first board portion by a predetermined distance.

Further, a disk brake according to the present invention includes a motor, a rotation-linear motion conversion mechanism configured to convert a rotational motion transmitted from an output shaft of the motor into a linear motion to cause a frictional pad to be pressed, a first board portion connected to the motor and disposed on a radially outer side of the motor, and a second board portion connected to the first board portion and disposed so as to face the first board portion and be spaced apart from the first board portion by a predetermined distance.

The disk brake according to one aspect of the present invention can suppress the transfer of the vibration and/or the heat passed from the motor or the disk rotor to the component mounted on the board, thereby improving the reliability as a result thereof.

### BRIEF DESCRIPTION OF DRAWINGS

FIG. 1 is a perspective view of a disk brake according to an embodiment of the present invention.

FIG. 2 is a perspective view of the disk brake according to the embodiment of the present invention as viewed from a direction different from FIG. 1.

FIG. 3 is a plan view of the disk brake according to the embodiment of the present invention, illustrating a part thereof in cross-section.

FIG. 4 is a side view of the disk brake according to the embodiment of the present invention, illustrating a part thereof in cross-section.

FIG. 5 is a plan view of a control portion employed in the disk brake according to the embodiment of the present invention.

FIG. 6 is a side view of the control portion employed in the disk brake according to the embodiment of the present invention.

FIG. 7 is a side view of a disk brake according to another embodiment, illustrating a part thereof in cross-section.

### DESCRIPTION OF EMBODIMENTS

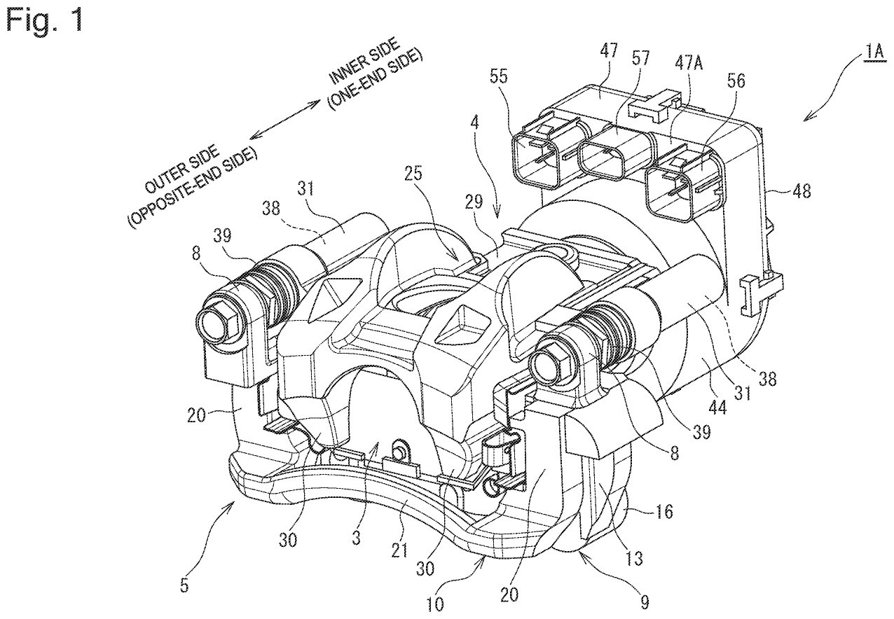

In the following description, embodiments of the present invention will be described in detail with reference to FIGS. 1 to 7.

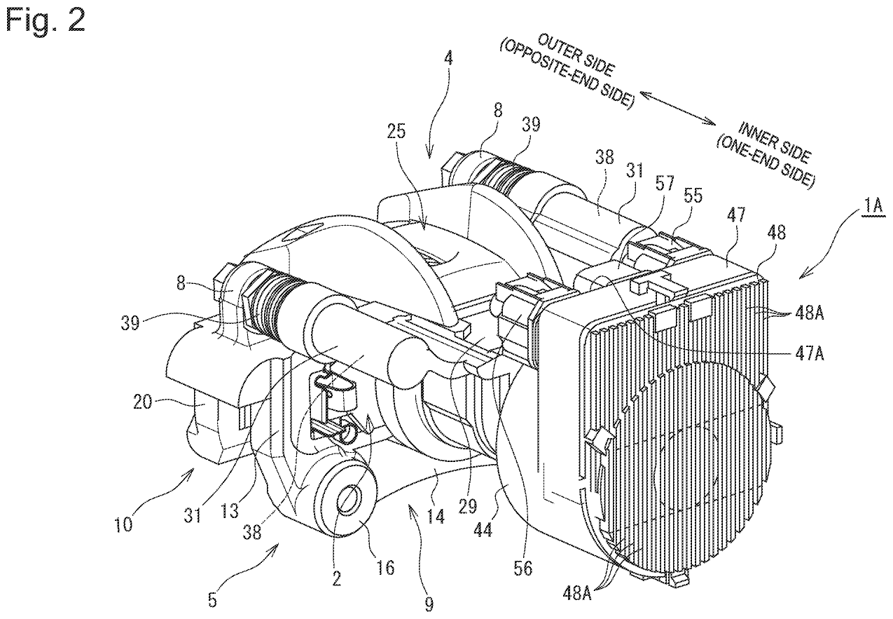

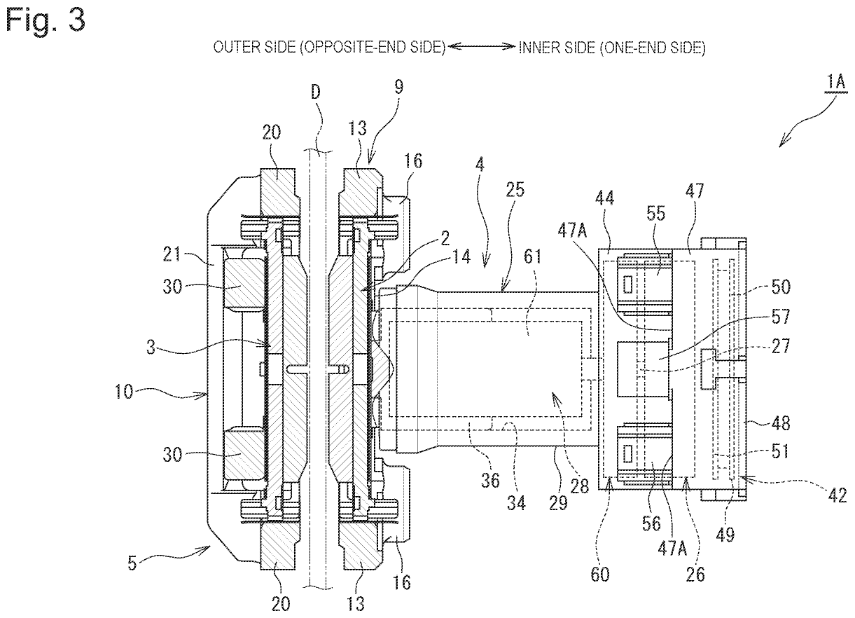

A disk brake 1A according to an embodiment of the present invention is an electric brake apparatus that generates a braking force based on driving of an electric motor 26 (refer to FIG. 3), and is employed as a braking apparatus used, for example, when a vehicle runs normally, at the time of parking brake, and the like. In the following description, the inner side of the vehicle will be referred to as an inner side, and the outer side of the vehicle will be referred to as an outer side. Further, the inner side may be referred to as a one-end side and the outer side may be referred to as an opposite-end side as necessary. Referring to FIGS. 1 to 3, the disk brake 1A according to the present embodiment includes a pair of inner and outer brake pads 2 and 3 and a caliper 4. The inner brake pad 2 (refer to FIG. 2) and the outer brake pad 3 (refer to FIG. 1) are disposed on both the axial sides of a disk rotor D (refer to FIG. 3) mounted at a rotational portion of the vehicle. The illustration of the disk rotor D is omitted in FIGS. 1 and 2.

Referring to FIGS. 1 to 3, the disk brake 1A according to the present embodiment is configured as a floating caliper-type disk brake. The pair of inner and outer brake pads 2 and 3, and the caliper 4 are supported on a carrier 5 movably relative to this carrier 5 in the axial direction of the disk rotor D. The carrier 5 is fixed to a non-rotational portion such as a knuckle (not illustrated) of the vehicle. The pair of inner and outer brake pads 2 and 3 corresponds to a frictional pad.

Referring to FIGS. 1 to 3, the carrier 5 includes a pair of pin coupled portions 8 and 8 and inner-side and outer-side support portions 9 and 10. Slide pins 38 and 38, which will be described below, are coupled with the pin coupled portions 8 and 8, respectively. The inner-side and outer-side support portions 9 and 10 are integrally connected to the pair of pin coupled portions 8 and 8, and support the inner and outer brake pads 2 and 3 independently, respectively. The pair of pin coupled portions 8 and 8 is disposed at an interval along the rotational direction of the disk rotor D. Each of the pin coupled portions 8 is integrally connected to an inner-side arm portion 13 of the inner-side support portion 9, which will be described below, and an outer-side arm portion 20 of the outer-side support portion 10, which will be described below, and is provided in a protruding manner on each pin slidable portion 31 side, which will be described below.

The inner-side support portion 9 includes a pair of inner-side arm portions 13 and 13 and an inner-side beam portion 14. The pair of inner-side arm portions 13 and 13 is disposed at an interval along the rotational direction of the disk rotor D, and extends in a direction perpendicular to the axial direction of the slid pins 38, which will be described below. The inner-side beam portion 14 connects the end portions of this pair of inner-side arm portions 13 and 13 on the opposite side from the pin coupled portions 8. The inner brake pad 2 is supported movably along the axial direction of the disk rotor D within the pair of inner-side arm portions 13 and 13 of the inner-side support portion 9. A pair of fixation portions 16 and 16 is integrally connected to the both ends of the inner-side beam portion 14 in the rotational direction of the disk rotor D. The pair of fixation portions 16 and 16 is used to fix the carrier 5 to the non-rotational portion of the vehicle.

The outer-side support portion 10 includes a pair of outer-side arm portions 20 and 20 and an outer-side beam portion 21. The pair of outer-side arm portions 20 and 20 is disposed on the outer side at an interval from the pair of inner-side arm portions 13 and 13 of the inner-side support portion 9. The outer-side beam portion 21 connects the end portions of this pair of outer-side arm portions 20 and 20 on the opposite side from the pin coupled portions 8. The outer brake pad 3 is supported movably along the axial direction of the disk rotor D within the pair of outer-side arm portions 20 and 20 of the outer-side support portion 10. Then, the carrier 5 is fixed to the non-rotational portion of the vehicle via the pair of fixation portions 16 and 16 of the inner-side support portion 9.

Referring to FIG. 3, the caliper 4 includes a caliper main body 25, the electric motor 26, and a braking mechanism 28. The caliper main body 25 constitutes the main body of this caliper 4. The braking mechanism 28 is provided in the caliper main body 25 and includes a speed reduction mechanism 60 and a rotation-linear motion conversion mechanism 61, and transmits a driving force input from the electric motor 26 to a piston 36 in a cylinder portion 29 of the caliper main body 25 via the speed reduction mechanism 60 and the rotation-linear motion conversion mechanism 61. Also referring to FIGS. 1 and 2, the cylindrical cylinder portion 29, a pair of claw portions 30 and 30, and the pair of pin slidable portions 31 and 31 are integrally formed on the caliper main body 25. The cylinder portion 29 is disposed on the proximal end side facing the inner brake pad 2, and is opened in face of this inner brake pad 2. The pair of claw portions 30 and 30 extends from the cylinder portion 29 to the outer side across over the disk rotor D, and is disposed on the distal end side facing the outer brake pad 3. The pair of pin slidable portions 31 and 31 is provided in a manner protruding from positions of the cylinder portion 29 at an interval along the rotational direction of the disk rotor D. FIG. 2 illustrates the cylinder portion 29, omitting the illustration of detailed planarly-viewed shapes of, for example, bulging portions around the base portions of the pair of claw portions 30 and 30 for facilitating a better understanding.

Referring to FIG. 3, a generally circular cylinder bore 34 is formed in the cylinder portion 29. The cylinder bore 34 is opened from the opposite-end surface of the cylinder portion 29. The piston 36 is inserted in this cylinder bore 34 non-rotatably and axially movably relative to the cylinder portion 29. The piston 36 has, for example, a cupped shape including a cylindrical portion and a bottom portion, and the axial direction thereof matches the axial directions of the disk rotor D and the slide pins 38. Then, as will be described in detail below, at the time of braking, the driving force from the electric motor 26 is transmitted to the piston 36 in the cylinder portion 29 via the braking mechanism 28, and this piston 36 presses the inner brake pad 2 with the bottom portion thereof while advancing toward the disk rotor D. On the other hand, at the time of braking release, the driving force from the electric motor 26 is transmitted to the piston 36 via the braking mechanism 28, causing the piston 36 to be retracted from the disk rotor D.

Referring to FIGS. 1 to 3, the pair of pin slidable portions 31 and 31 is each integrally provided on the cylinder portion 29 of the caliper main body 25 in an outward protruding manner along the rotational direction of the disk rotor D. Each of the pin slidable portions 31 extends along the axial direction of the disk rotor D. Each of the pin slidable portions 31 is formed into a bottomed cylindrical shape with the opposite-end surface thereof opened. The pair of slide pins 38 and 38 is axially slidably inserted through inside the pair of pin slidable portions 31 and 31, respectively. Each of the pin slidable portions 31 and 31 is disposed on the one-end side with respect to the pair of pin coupled portions 8 and 8 of the carrier 5. The slide pins 38 extend along the axial direction of the disk rotor D. The slide pins 38 are each formed into an elongated circular shape in cross-section.

Then, the pair of slide pins 38 and 38 is axially slidably inserted through inside the pin slidable portions 31 and 31 provided on the cylinder portion 29 from the opposite-end side, respectively. The pair of slide pins 38 and 38 is coupled with the respective corresponding pin coupled portions 8 and 8 of the carrier 5, respectively. Pin boots 39 and 39 are provided. The pin boots 39 and 39 each include an extendable and compressible bellows portion so as to cover each of the slide pins 38 and 38. As a result, the caliper main body 25 (the caliper 4) can be supported slidably along the axial direction of the disk rotor D relative to the carrier 5 due to sliding movements of the pair of slide pins 38 and 38 in the respective pin slidable portions 31 and 31 provided on the cylinder portion 29.

A control portion (ECU) 42 is electrically connected to the electric motor 26. The control portion 42 functions to control a rotation of the electric motor 26. The electric motor 26 is housed in a cylindrical motor/gear housing 44, which is disposed on the one-end side with respect to the bottom portion of the cylinder portion 29. The electric motor 26 is disposed in the motor/gear housing 44 on the one-end side thereof. A rotational shaft 27 of the electric motor 26 extends toward the opposite-end side, and the rotational driving thereof is transmitted to the speed reduction mechanism 60, which will be described below. The rotational shaft 27 corresponds to an output shaft. The axial direction of the rotational shaft 27 of the electric motor 26 matches the axial direction of the disk rotor D. The rotational shaft 27 of the electric motor 26 and the cylinder bore 34 of the cylinder portion 29 are disposed generally concentrically with each other.

The control portion 42 functions to control the rotation of the electric motor 26 (a rotational direction, a rotational speed, and the like) based on various detection signals, such as a detection signal from a detection sensor that responds to a request of a driver or a detection sensor that detects various situations requiring the brake, a detection signal from a wheel speed detection sensor that detects a wheel speed, a detection signal from a rotational angle detector (not illustrated) that detects a rotational angle of the rotational shaft 27 of the electric motor 26, and a detection signal from a thrust force sensor (not illustrated) that detects a thrust force (a pressing force) applied from the inner and outer brake pads 2 and 3 to the disk rotor D at the time of braking while the vehicle runs normally. The control portion 42 is disposed on the one-end side with respect to the electric motor 26. In other words, the electric motor 26 is disposed so as to be interposed between the control portion 42 (a first board portion 50 and a second board portion 51, which will be described below) and the speed reduction mechanism 60, which will be described below, along the axial direction of the rotational shaft 27 thereof.

The control portion 42 is housed in a control portion housing 47. The control portion housing 47 is integrally connected with the motor/gear housing 44. The control portion housing 47 is disposed on the one-end side continuously from the motor/gear housing 44, i.e., disposed opposite from the disk rotor D. Further, the control portion housing 47 is configured to protrude from the motor/gear housing 44 in a direction opposite from one side closer to the inner-side and outer-side beam portions 14 and 21 of the inner-side and outer-side support portions 9 and 10. Due to that, on the control portion housing 47, an opposite-end surface 47A thereof (refer to FIGS. 1 and 3) is exposed from the motor/gear housing 44 to the opposite side from the inner-side and outer-side beam portions 14 and 21 of the inner-side and outer-side support portions 9 and 10. The opening of the control portion housing 47 on the one-end side is closed by a cover member 48. A highly thermally conductive material, such as aluminum, is employed for the cover member 48. A large number of heat dissipation fins 48A are provided on the outer peripheral surface of the cover member 48.

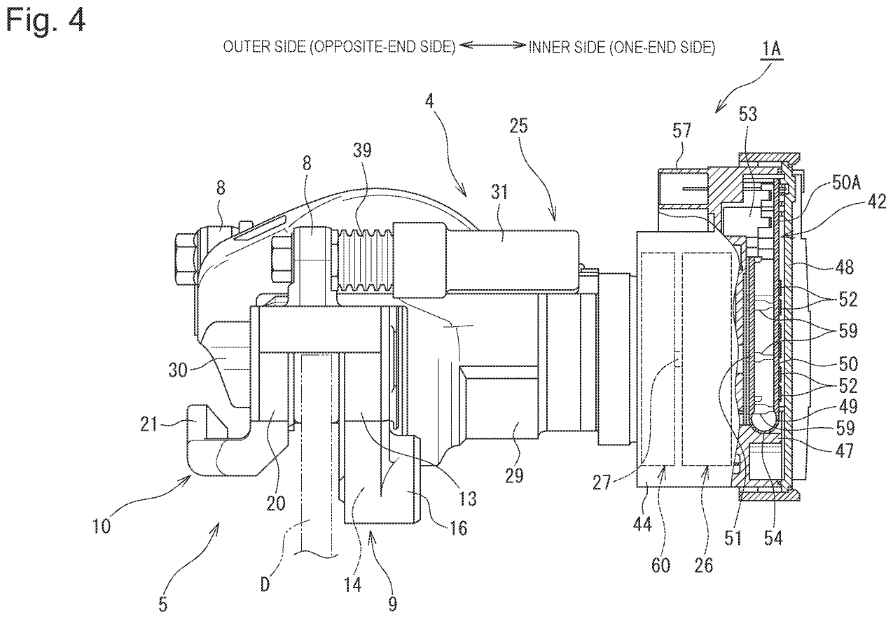

Referring to FIGS. 3 and 4, the control portion 42 includes the first board portion 50 and the second board portion 51 formed by folding one long control board 49 into two layers. The control portion 42, i.e., the first board portion 50 and the second board portion 51 are disposed at positions away from the rotational shaft 27 of the electric motor 26, more specifically, disposed opposite from the rotational shaft 27 side of the electric motor 26 in the axial direction thereof. In other words, the control portion 42, the electric motor 26 including the rotational shaft 27, and the speed reduction mechanism 60 are arranged in this order in the control portion housing 47 and the motor/gear housing 44 from the one-end side toward the opposite-end side thereof. Also referring to FIG. 6, the first board portion 50 and the second board portion 51 are disposed so as to face each other at a predetermined distance therebetween along the axial direction of the disk rotor D. Reference numerals 59 illustrated in FIG. 4 each indicate an electro-mechanical connection terminal.

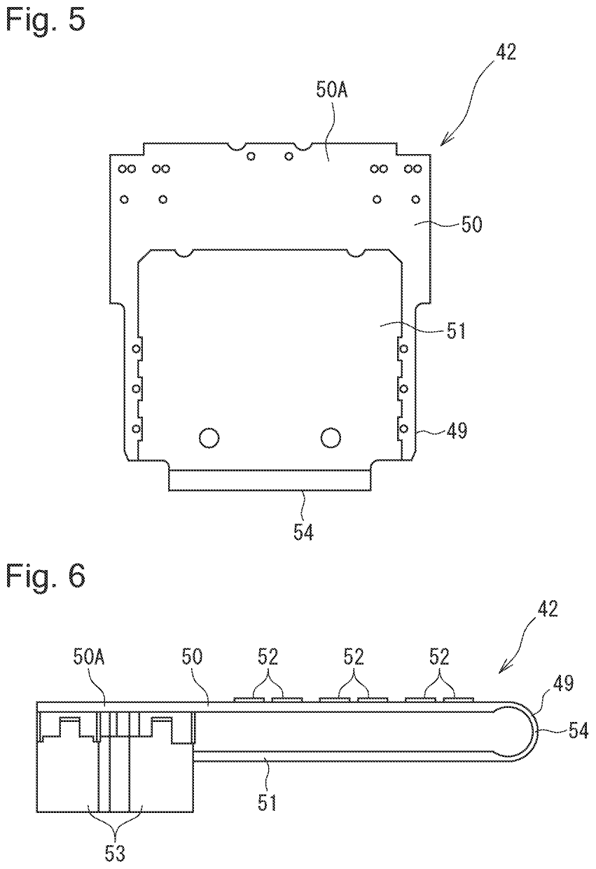

Referring to FIG. 5, both the first board portion 50 and the second board portion 51 are formed into generally rectangular shapes. Referring to FIGS. 3 and 4, the first board portion 50 is disposed on the cover member 48 side. The second board portion 51 is disposed on the electric motor 26 side (the disk rotor D side). In other words, the first board portion 50 is disposed opposite of the second board portion 51 from the disk rotor D in the axial direction thereof. A folded portion 54 is formed between the first board portion 50 and the second board portion 51. The folded portion 54 is disposed on the one side closer to the inner-side and outer-side beam portions 14 and 21 of the inner-side and outer-side support portions 9 and 10. The first board portion 50 is mainly used for a power source circuit (a power system). The second board portion 51 is mainly used for a control circuit to which signals are input from various detection sensors of the vehicle (a signal system).

Referring to FIGS. 4 and 6, a large number of heat-generating components 52, such as a semiconductor switching element, are mounted on the first board portion 50. Because the first board portion 50 with the large number of heat-generating components 52 mounted thereon is placed close to the cover member 48, heat dissipation to outside air can be improved by employing the above-described highly thermally conductive material such as aluminum for the cover member 48. Referring to FIG. 5, the first board portion 50 is larger than the second board portion 51 in area. Referring to FIG. 4, the first board portion 50 protrudes beyond the second board portion 51 to a first to third connector 55, 56, and 57 side, which will be described below, i.e., to the opposite side from the one side closer to the inner-side and outer-side beam portions 14 and 21 of the inner-side and outer-side support portions 9 and 10.

In other words, a protrusion portion 50A is provided on the first board portion 50 at a position where it does not overlap the second board portion 51 in the direction in which the disk rotor D is pressed by the inner and outer brake pads 2 and 3 (the axial direction of the disk rotor D). Referring to FIGS. 4 and 6, a tall component 53 such as an electrolytic capacitor longer than the predetermined distance between the first board portion 50 and the second board portion 51 is provided on the protrusion portion 50A of the first board portion 50. The illustration of the component 53 such as the electrolytic capacitor is omitted in FIG.

5. The protrusion portion 50A of the first board portion 50 is disposed inside a portion of the control portion housing 47 that protrudes from the motor/gear housing 44 (a portion having the opposite-end surface 47A).

The first board portion 50 is electrically connected to the electric motor 26 via this portion of the protrusion portion 50A. Each of the first connector 55, the second connector 56, and the third connector 57 is electrically connected to the control portion 42 (the first board portion 50 and the second board portion 51). Referring to FIGS. 4 and 6, the first connector 55, the second connector 56, and the third connector 57 are disposed at positions where they overlap the protrusion portion 50A of the first board portion 50 of the control portion 42 in the axial direction of the disk rotor D. Referring to FIGS. 1 to 3, the first connector 55, the second connector 56, and the third connector 57 are provided in a manner protruding from the opposite-end surface 47A of the control portion housing 47 to the opposite-end side, i.e., the disk rotor D side along the axial direction of the disk rotor D.

This facilitates electrically connecting the first connector 55, the second connector 56, and the third connector 57, and the first board portion 50 and the second board portion 51. The first connector 55, the second connector 56, and the third connector 57 are arranged so as to be lined up in alignment. More specifically, the first connector 55, the second connector 56, and the third connector 57 are disposed so as to be lined up in alignment along the same direction as the direction in which the inner-side and outer-side beam portions 14 and 21 of the inner-side and outer-side support portions 9 and 10 extend. The third connector 57 is disposed so as to be interposed between the first connector 55 and the second connector 56.

Referring to FIG. 3, the braking mechanism 28 is provided in the caliper main body 25, and includes the speed reduction mechanism 60 and the rotation-linear motion conversion mechanism 61. The speed reduction mechanism 60 powers up a rotational torque input from the electric motor 26. The rotation-linear motion conversion mechanism 61 converts the rotational motion input from this speed reduction mechanism 60 into a linear motion to provide a thrust force to the piston 36. The rotation from the rotational shaft 27 of the electric motor 26 is transmitted to the speed reduction mechanism 60. The speed reduction mechanism 60 functions to power up the rotational torque input from the electric motor 26 and transmit it to the rotation-linear motion conversion mechanism 61. This speed reduction mechanism 60 is housed in the motor/gear housing 44 on the opposite-end side (the cylinder portion 29 side) with respect to the electric motor 26. For example, a planetary gear speed reduction mechanism is employed as the speed reduction mechanism 60. The rotation-linear motion conversion mechanism 61 is disposed between the bottom portion of cylinder portion 29 and the piston 36 in the cylinder bore 34 of the cylinder portion 29. The rotation-linear motion conversion mechanism 61 functions to convert the rotational motion input from the speed reduction mechanism 60 into a linear motion to provide a thrust force to the piston 36. A ball screw mechanism, a ball and ramp mechanism, or the like is employed as the rotation-linear motion conversion mechanism 61.

Then, in the disk brake 1A according to the present embodiment, for example, the detection signal from the detection sensor that responds to the request of the driver or the detection sensor that detects various situations requiring the brake is input to the control portion 42 via the first or second connector 55 or 56 at the time of braking while the vehicle runs normally. Further, for example, the detection signal from the wheel speed detection sensor that detects the wheel speed is input to the control portion 42 via the third connector 57. Further, for example, the detection signal from the rotational angle detector that detects the rotational angle of the rotational shaft 27 of the electric motor 26, and the detection signal from the thrust force sensor that detects the thrust force applied from the inner and outer brake pads 2 and 3 to the disk rotor D are input to the control portion 42. Furthermore, power is supplied from a not-illustrated power source device to the control portion 42 via the first or second connector 55 or 56.

Subsequently, the control portion 42 controls a rotation of the rotational shaft 27 of the electric motor 26 that is directed in a forward direction. i.e., a braking direction based on these detection signals. This rotation from the electric motor 26 is transmitted to the speed reduction mechanism 60 of the braking mechanism 28. Subsequently, the rotation powered up by the speed reduction mechanism 60 is transmitted to the rotation-linear motion conversion mechanism 61 of the braking mechanism 28. The rotational motion from the speed reduction mechanism 60 is converted into the linear motion by this rotation-linear motion conversion mechanism 61, by which the piston 36 advances and the inner pad 2 presses the disk rotor D due to the advancement of this piston 36.

Then, due to a reaction force to the pressing force applied from the piston 36 to the inner brake pad 2, the caliper main body 25 (the caliper 4) moves to the inner side relative to the carrier 5 according to the axial sliding movements of the pair of slide pins 38 and 38 in the pair of pin slidable portions 31 and 31, and the outer brake pad 3 in contact with the pair of claw portions 30 and 30 presses the disk rotor D. As a result, the disk rotor D is sandwiched between the pair of inner and outer brake pads 2 and 3, and a frictional force is generated and a braking force is generated on the vehicle.

On the other hand, at the time of braking release, the rotational shaft 27 of the electric motor 26 is rotationally controlled in a reverse direction, i.e., a release direction according to an instruction from the control portion 42 (the first board portion 50 and the second board portion 51). Subsequently. the rotation in the reserve direction is transmitted from the electric motor 26 to the rotation-linear motion conversion mechanism 61 via the speed reduction mechanism 60 of the braking mechanism 28. As a result, the piston 36 is retracted to return into an initial state, and the braking force applied by the pair of inner and outer brake pads 2 and 3 to the disk rotor D is released.

In the above-described disk brake 1A according to the present embodiment, the control portion 42. i.e., the first board portion 50 and the second board portion 51 are disposed at positions away from the rotational shaft 27 of the electric motor 26, more specifically, disposed opposite from the rotational shaft 27 side of the electric motor 26 in the axial direction thereof. This can contribute to suppressing a transfer of a vibration and/or heat passed from the rotational shaft 27 of the electric motor 26 to the components mounted on the first board portion 50 and the second board portion 51 of the control portion 42, and thus reducing a malfunction of the components mounted on the first board portion 50 and the second board portion 51. Then, the reliability of the present disk brake LA is improved.

Further, in the disk brake 1A according to the present embodiment, the heat-generating components 52 are mounted on the first board portion 50, and the heat-generating components 52 of the first board portion 50 and the rotational shaft 27 of the electric motor 26 are disposed so as to be spaced apart from each other. This layout can contribute to suppressing a further vibration and/or heat passed from the electric motor 26 including the rotational shaft 27 to the first board portion 50 including the heat-generating components 52 and subjected to a concern about a temperature increase, thereby suppressing a further increase in the temperature of the first board portion 50 as a result thereof.

Further, in the disk brake 1A according to the present embodiment, the first board portion 50 is disposed opposite of the second board portion 51 from the disk rotor D in the axial direction thereof. This can contribute to further suppressing a vibration and/or heat passed from the electric motor 26 including the rotational shaft 27 and the disk rotor D to the first board portion 50 including the heat-generating components 52.

Furthermore, in the disk brake 1A according to the present embodiment, the control portion 42 can be provided with the protrusion portion 50A on the first board portion 50 by having a larger area for the first board portion 50 than the area of the second board portion 51. Then, the first connector 55. the second connector 56, and the third connector 57 can be disposed at positions where they overlap the protrusion portion 50A of the first board portion 50 in the axial direction of the disk rotor D. This facilitates electrically connecting the first connector 55, the second connector 56, and the third connector 57. and the control portion 42 (the first board portion 50 and the second board portion 51) as a result thereof.

Furthermore, in the disk brake 1A according to the present embodiment. the first connector 55, the second connector 56, and the third connector 57 can be provided at positions where they overlap the protrusion portion 50A of the first board portion 50 in the axial direction of the disk rotor D in a manner protruding from the opposite-end surface 47A of the control portion housing 47 toward the inner and outer brake pad 2 and 3 side along the axial direction of the disk rotor D. This prevents the first connector 55, the second connector 56, and the third connector 57 from being arranged so as to protrude from the entire silhouette of the caliper main body 25, thereby improving the layout flexibility, i.e., the mountability onto a vehicle.

Furthermore, in the disk brake 1A according to the present embodiment, in the control portion 42, the first board portion 50 is connected to the electric motor 26 via the protrusion portion 50A of the first board portion 50 that does not overlap the second board portion 51 in the direction in which the disk rotor D is pressed by the inner and outer brake pads (the axial direction of the disk rotor D). This eliminates the necessity of providing a hole or the like to the second board portion 51 and thus facilitates the circuit design as a result thereof. Further, the tall component 53 such as the electrolytic capacitor longer than the predetermined distance between the first board portion 50 and the second board portion 51 is provided on the position of this protrusion portion 50A. This can minimize the distance between the first board portion 50 and the second board portion 51 and thus reduce the total length thereof as a result thereof. This contributes to a reduction in the size of the disk brake 1A as a result thereof.

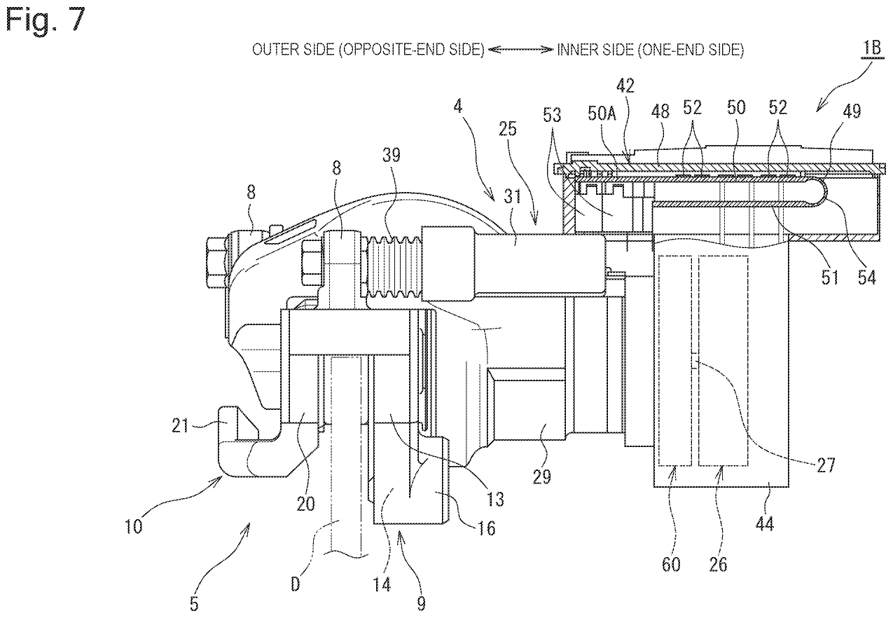

Next, a disk brake 1B according to another embodiment will be described with reference to FIG. 7. The disk brake 1B according to the other embodiment will be described focusing only on differences from the above-described disk brake 1A.

In the disk brake 1B according to the other embodiment, the control portion housing 47 including the cover member 48 is disposed on the radially outer side of the electric motor 26 with respect to the motor/gear housing 44 and at a position opposite from the inner-side and outer-side beam portions 14 and 21 of the inner-side and outer-side support portions 9 and 10. Then, the control portion 42 including the first board portion 50 and the second board portion 51 is disposed in the control portion housing 47. As a result, the control portion 42 is disposed at a position away from the rotational shaft 27 of the electric motor 26, on the radially outer side of the electric motor 26, and opposite from the inner-side and outer-side beam portions 14 and 21 of the inner-side and outer-side support portions 9 and 10. In other words, the control portion 42 is located at a position away from the rotational shaft 27 of the electric motor 26 and on a plane parallel with the rotational shaft 27 of the electric motor 26.

The first board portion 50 is disposed on the cover member 48 side away from the electric motor 26. The second board portion 51 is disposed on the electric motor 26 side (the one side closer to the inner-side and outer-side beam portions 14 and 21 of the inner-side and outer-side support portions 9 and 10). The protrusion portion 50A of the first board portion 50 is disposed on the one-end side, i.e., the disk rotor D side. The folded portion 54 between the first board portion 50 and the second board portion 51 is disposed on the opposite-end side, i.e., disposed opposite from the disk rotor D.

Then, in the above-described disk brake 1B according to the other embodiment, the control portion 42 is also disposed at the position away from the rotational shaft 27 of the electric motor 26 and on the radially outer side of the electric motor 26. This can contribute to suppressing the transfer of a vibration and/or heat passed from the rotational shaft 27 of the electric motor 26 to the first board portion 50 and the second board portion 51 of the control portion 42, and thus reducing a malfunction of the components mounted on the first board portion 50 and the second board portion 51 as a result thereof, similarly to the disk brake IA according to the embodiment illustrated in FIGS. 1 to 6.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2021-207082 filed on Dec. 21, 2021. The entire disclosure of Japanese Patent Application No. 2021-207082 filed on Dec. 21, 2021 including the specification, the claims, the drawings, and the abstract is incorporated herein by reference in its entirety.

### Reference Signs List

1A, 1B disk brake
2 inner brake pad (frictional pad)
3 outer brake pad (frictional pad)
26 electric motor (motor)
27 rotational shaft (output shaft)
42 control portion
50 first board portion
50A protrusion portion
51 second board portion
52 heat-generating component
53 component
61 rotation-linear motion conversion mechanism
D disk rotor

1. A disk brake comprising:
a motor;
a rotation-linear motion conversion mechanism configured to convert a rotational motion transmitted from an output shaft of the motor into a linear motion to cause a frictional pad to be pressed;
a first board portion connected to the motor and disposed opposite from an output shaft side of the motor in an axial direction of the output shaft; and
a second board portion connected to the first board portion and disposed so as to face the first board portion and be spaced apart from the first board portion by a predetermined distance.

2. The disk brake according to claim 1, wherein the frictional pad is pressed against a disk rotor, and
wherein the first board portion is disposed opposite of the second board portion from the disk rotor in an axial direction of the disk rotor.

3. The disk brake according to claim 1, wherein the first board portion includes a portion that does not overlap the second board portion in a direction in which the disk rotor is pressed by the frictional pad, and a component longer than the predetermined distance is mounted on the portion.

4. A disk brake comprising:
a motor;
a rotation-linear motion conversion mechanism configured to convert a rotational motion transmitted from an output shaft of the motor into a linear motion to cause a frictional pad to be pressed;
a first board portion connected to the motor and disposed on a radially outer side of the motor; and
a second board portion connected to the first board portion and disposed so as to face the first board portion and be spaced apart from the first board portion by a predetermined distance.

5. The disk brake according to claim 1, wherein a heat-generating component is mounted on the first board portion.

6. The disk brake according to claim 1, wherein the first board portion is larger than the second board portion in area.

7. The disk brake according to claim 2, wherein the first board portion includes a portion that does not overlap the second board portion in a direction in which the disk rotor is pressed by the frictional pad, and a component longer than the predetermined distance is mounted on the portion.

8. The disk brake according to claim 2, wherein a heat-generating component is mounted on the first board portion.

9. The disk brake according to claim 3, wherein a heat-generating component is mounted on the first board portion.

10. The disk brake according to claim 4, wherein a heat-generating component is mounted on the first board portion.

11. The disk brake according to claim 7, wherein a heat-generating component is mounted on the first board portion.

12. The disk brake according to claim 2, wherein the first board portion is larger than the second board portion in area.

13. The disk brake according to claim 3, wherein the first board portion is larger than the second board portion in area.

14. The disk brake according to claim 4, wherein the first board portion is larger than the second board portion in area.

15. The disk brake according to claim 5, wherein the first board portion is larger than the second board portion in area.

16. The disk brake according to claim 7, wherein the first board portion is larger than the second board portion in area.
